(19) United States
(12) Patent Application Publication
(10) Pub. No.: US 2016/0352845 A1
(43) Pub. Date: Dec. 1, 2016

(54) RIDE-SHARING SYSTEM AND METHOD

(71) Applicant: HON HAI PRECISION INDUSTRY CO., LTD., New Taipei (TW)

(72) Inventors: SHU-KAN NIEH, New Taipei (TW); KUANG-YAO LIAO, New Taipei (TW); HSIEN-HOU CHEN, New Taipei (TW); HUI-HSUAN CHOU, New Taipei (TW)

(21) Appl. No.: 15/057,691

(22) Filed: Mar. 1, 2016

(30) Foreign Application Priority Data
May 29, 2015 (TW) 104117340

(51) Int. Cl. H04L 29/08; H04B 1/3827

(52) U.S. Cl. CPC H04L 67/18; H04L 67/10; H04B 1/385; H04B 2001/3866

(57) ABSTRACT

A system for implementing a ride-sharing method includes a cloud server, a first terminal device in wireless connection with the cloud server, at least one second terminal device in wireless connection with the cloud server, a first helmet in wireless connection with the first terminal device, and a second helmet in wireless connection with the at least one second terminal device. The first terminal device generates a ride-sharing request and transmits the ride-sharing request to the cloud server. The cloud server transmits the ride-sharing request to the at least one second terminal device. The at least one second terminal device generates a ride-sharing confirmation and transmits the ride-sharing confirmation to the cloud server. The cloud server transmits the ride-sharing confirmation to the first terminal device. A user of the first terminal device selects one second terminal device to share a ride.

### CROSS-REFERENCE TO RELATED APPLICATIONS

This application claims priority to Taiwanese Patent Application No. 104117340 filed on May 29, 2015, the contents of which are incorporated by reference herein.

### FIELD

The subject matter herein generally relates to a system for implementing a ride-sharing method.

### BACKGROUND

A method for sharing a ride may include a first user sending a request to get picked up by a second user.

### BRIEF DESCRIPTION OF THE DRAWINGS

Implementations of the present technology will now be described, by way of example only, with reference to the attached figures.

FIG. 1 is a block diagram of an embodiment of a system for implementing a ride-sharing method.

FIG. 2 is a flowchart of an embodiment of a ride-sharing method.

FIG. 3 is a continuation of the flowchart of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

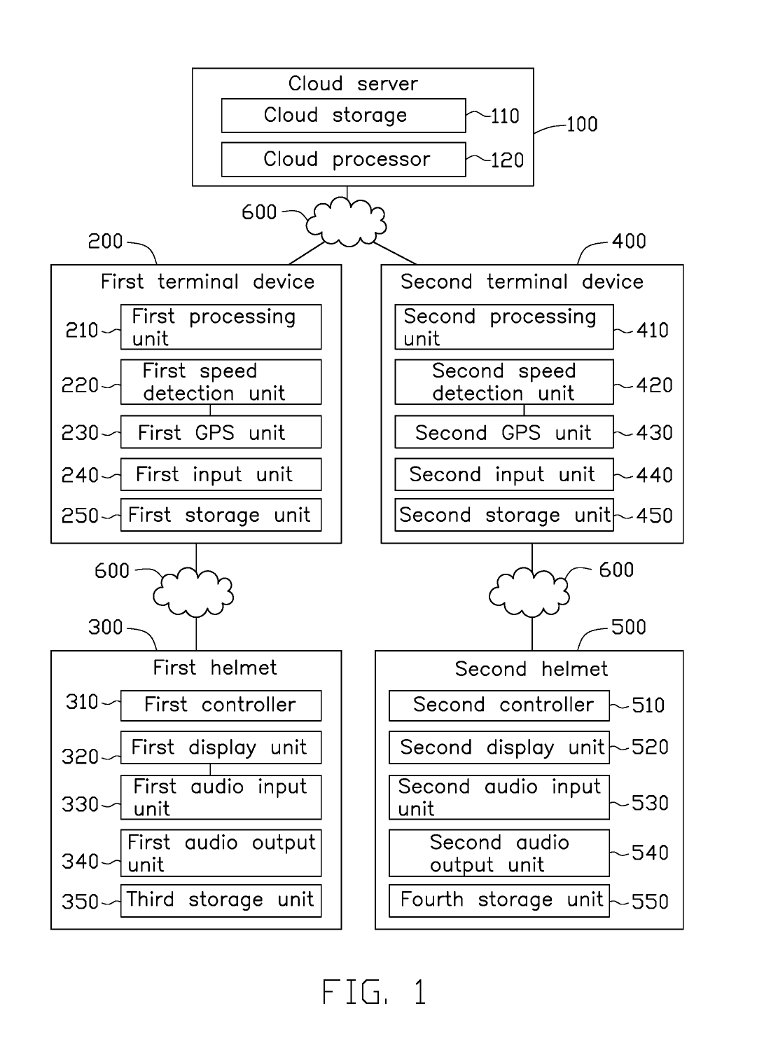

FIG. 1 illustrates an embodiment of a system for implementing a ride-sharing method. The system can include a cloud server 100, a first terminal device 200, a first helmet 300 paired with the first terminal device 200, at least one second terminal device 400, and a second helmet 500 paired with the at least one second terminal device 400. For simplicity and clarity of illustration, one first terminal device 200, one first helmet 300, one second terminal device 400, and one second helmet 500 are illustrated. The first terminal device 200 and the at least one second terminal device 400 can be in wireless communication with the cloud server 100 through a network 600. The first helmet 300 and the second helmet 500 can be in wireless communication with the first terminal device 200 and the at least one second terminal device 400, respectively, through the network 600.

In at least one embodiment, the network 600 wirelessly connecting the first helmet 300 and the second helmet 500 to the first terminal device 200 and the at least one second terminal device 400 is a short distance network, such as BLUETOOTH. In at least one embodiment, the first terminal device 200 and the second terminal device 400 can be, but are not limited to, a mobile phone, a tablet computer, or any other portable electronic device having wireless transmission capabilities. The first helmet 300 and the at least one second helmet 500 can be, but are not limited to, a smart safety helmet having wireless transmission capabilities. The network 600 wirelessly connecting the first terminal device 200 and the second terminal device 400 to the cloud server 100 can be, but is not limited to, WIFI, 3G network, 4G network, or the like.

The first terminal device 200 and the at least one second terminal device 400 can be registered on the cloud server 100 through the network 600. Registration information of the first terminal device 200 and the at least one second terminal device 400 can be saved in the cloud server 100 to allow the first terminal device 200 and the at least one second terminal device 400 to log onto the cloud server 100.

The first terminal device 200 logged onto the cloud server 100 can generate a ride-sharing request in response to user input thereon and transmit the ride-sharing request to the cloud server 100. In at least one embodiment, the first terminal device 200 can only generate the ride-sharing request when the first helmet 300 is within a predetermined distance from the first terminal device 200, such as the range of the network 600 between the first terminal device 200 and the first helmet 300. In at least one embodiment, the ride-sharing request can be in the form of an audio input by a user of the first terminal device 200. For example, the ride-sharing request can say, “I am on Second Street. I want to go to Main Street.” The cloud server 100 can transmit the ride-sharing request to the at least one second terminal device 400 logged onto the cloud server 100. The at least one second terminal device 500 can generate a ride-sharing confirmation in response to user input thereon and transmit the ride-sharing confirmation to the cloud server 100. In at least one embodiment, the at least one second terminal device 400 can only generate the ride-sharing request when the second helmet 500 is within a predetermined distance from the second terminal device 400, such as the range of the network 600 between the second terminal device 400 and the second helmet 500. In at least one embodiment, the ride-sharing confirmation is in the form of an audio input by a user of the second terminal device 400. For example, the ride-sharing confirmation can say, “I am at Second Street. I can take you to Main Street.” The cloud server 100 can transmit the ride-sharing confirmation to the first terminal device 200.

In another embodiment, the ride-sharing request can be generated by the first helmet 300, and the ride-sharing confirmation can be generated by the second helmet 500. In another embodiment, the cloud-server 100 can transmit the ride-sharing request to the at least one second terminal device 400 either logged onto the cloud server 100 or not logged onto the cloud server 100. In another embodiment, the cloud server 100 can transmit the ride-sharing confirmation to all online and offline first terminal devices 200 and second terminal devices 400.

The first terminal device 200 can generate a selection message in response to user input thereon and transmit the selection message to the cloud server 100. The selection message can include information of one second terminal device 400 selected by a user of the first terminal device 200. The information can include the identification information and position information of the selected second terminal device 400 and the ride-sharing confirmation. The cloud server 100 can transmit the selection message to the selected second terminal device 400 according to the identification information. Thus, a user of the first terminal device 200 can select the user of the second terminal device 400 to share a ride.

The cloud server 100 can include a cloud storage 110 and a cloud processor 120. In at least one embodiment, the cloud storage 110 can store a user information database, police contact information, a reward system, and a predetermined speed limit. The user information database can include the registration information of the first terminal device 200 and the at least one second terminal device 400 and store the identification information of the at least one second terminal device 400. The first terminal device 200 can transmit the ride-sharing request to the cloud server 100 after logging onto the cloud server 100, and the cloud server 100 can transmit the ride-sharing request to the at least one second terminal device 400 logged onto the cloud server 100. The reward system can award a user of the at least one second terminal device 400 for sharing a ride with a user of the first terminal device 200. The predetermined speed limit refers to a maximum safe speed of travel for a user of the first terminal device 200 and the at least one second terminal device 400. For example, the predetermined speed limit of travel by car may be 60 miles per hour on the highway, and the predetermined speed limit of travel by electric bike may be 20 miles per hour downtown.

The first terminal device 200 can include a first processing unit 210, a first speed detection unit 220, a first global positioning system (GPS) unit 230, a first input unit 240, and a first storage unit 250. The first speed detection unit 220 can detect the speed of the first terminal device 200. The first GPS unit 230 can obtain position information of the first terminal device 200. The first input unit 240 can receive user input thereon. In at least one embodiment, the first input unit 240 is a touchscreen. The first storage unit 250 can store identification information of the first terminal device 200 and first user registration information of the first terminal device 200.

The first helmet 300 can include a first controller 310, a first display unit 320, a first audio input unit 330, a first audio output unit 340, and a third storage unit 350. The first display unit 320 can display information on the first helmet 300. The first audio input unit 330 can receive audio input, such as a voice of a user of the first helmet 300. In at least one embodiment, the first audio input unit 330 is a microphone. The first audio output unit 340 can play audio. In at least one embodiment, the first audio output unit 340 is a speaker. The third storage unit 350 can store the identification information of the first terminal device 200 and the first user registration information of the first terminal device 200.

The at least one second terminal device 400 can include a second processing unit 410, a second speed detection unit 420, a second global positioning system (GPS) unit 430, a second input unit 440, and a second storage unit 450. The second speed detection unit 420 can detect the speed of the second terminal device 400. The second GPS unit 430 can obtain position information of the second terminal device 400. The second input unit 440 can receive user input thereon. In at least one embodiment, the second input unit 440 is a touchscreen. The second storage unit 450 can store identification information of the second terminal device 400 and first user registration information of the second terminal device 400.

The second helmet 500 can include a second controller 510, a second display unit 520, a second audio input unit 530, a second audio output unit 540, and a fourth storage unit 550. The second display unit 520 can display information on the second helmet 500. The second audio input unit 530 can receive audio input, such as a voice of a user of the second helmet 500. In at least one embodiment, the second audio input unit 530 is a microphone. The second audio output unit 540 can play audio. In at least one embodiment, the second audio output unit 540 is a speaker. The fourth storage unit 550 can store the identification information of the second terminal device 400 and the second user registration information of the second terminal device 400.

In at least one embodiment, the ride-sharing request is in the form of an audio input to the first audio input unit 340 by a user of the first helmet 300. The first helmet 300 can transmit the ride-sharing request to the first terminal device 200 through the network 600, and the first terminal device 200 can transmit the ride-sharing request to the cloud server 100 through the network 600. In at least one embodiment, after the second terminal device 400 receives the ride-sharing request from the cloud server 100, the ride-sharing request transmitted to the second helmet 500 by the second terminal device 400 is in the form of an audio that is played by the second audio output unit 540 or in a form displayable on the second display unit 520. For example, the ride-sharing request can be converted to text by voice-to-text technology. In at least one embodiment, the ride-sharing confirmation is in the form of an audio input to the second audio input unit 540 by a user of the second helmet 500. The second helmet 500 can transmit the ride-sharing confirmation to the second terminal device 400 through the network 600, and the second terminal device 400 can transmit the ride-sharing confirmation to the cloud server 100 through the network 600. In at least one embodiment, after the first terminal device 200 receives the ride-sharing confirmation from the cloud server 100, the ride-sharing confirmation is transmitted to the first helmet 300 by the first terminal device 200 in the form of an audio that is played by the first audio output unit 340 or in a form displayable on the first display unit 320.

The cloud server 100 can obtain the position information of the first terminal device 200 and the selected second terminal device 400 from the first GPS unit 230 and the second GPS unit 430, respectively. The cloud server 100 can establish a first navigation route between the first terminal device 200 and the selected second terminal device 400 according to the location information. The cloud server 100 can further establish a second navigation route between the first terminal device 200 and a destination determined by the first terminal device 200.

In at least one embodiment, the cloud server 100 can determine whether the first terminal device 200 or the selected second terminal device 400 veers off course from the first navigation route or the second navigation route. When it is determined that the first terminal device 200 or the selected second terminal device 400 veers off course from the first or second navigation routes, the cloud server 100 can transmit an alert message to the first terminal device 200 or the selected second terminal device 400, respectively. In at least one embodiment, when the first terminal device 200 or the selected second terminal device 400 exceeds the predetermined speed limit, the cloud server 100 can transmit the alert message to the first terminal device 200 or the selected second terminal device 400, respectively. The alert message 300 can be transmitted to the corresponding first helmet 300 or the corresponding second helmet 500 by the first terminal device 200 or the selected second terminal device 400, respectively, through the network 600 and played as an audio through the first audio output unit 340 or the second audio output unit 540, respectively. The cloud server 100 can send an alarm message to the police according to the police contact information after a predetermined length of time of not receiving a feedback message after transmitting the alert message. In at least one embodiment, the feedback message can be an audio message input to the first audio input unit 330 or the second audio input unit 530. The feedback message generated by the first helmet 300 and the second helmet 500 can be transmitted to the first terminal device 200 and the second terminal device 400, respectively, through the network 600, and the first terminal device 200 and the second terminal device 400 can transmit the feedback message to the cloud server 100 through the network 600.

The cloud server 100 can send the alarm message to the police when no feedback message is received when the first terminal device 200 or the second terminal device 400 exceed the predetermined speed limit or veer off course from the first and second navigation paths. In addition, the first terminal device 200 can only generate the ride-sharing request when the first helmet 300 is within the predetermined distance from the first terminal device 200, and the second terminal device 400 can only generate the ride-sharing confirmation when the second helmet 500 is within the predetermined distance from the second terminal device 400. In addition, the ride-sharing request and the ride-sharing confirmation are generated in response to audio input, and the ride-sharing request, the ride-sharing confirmation, and the alert message are displayed by the corresponding display unit or played by the corresponding audio unit. Thus, safety of the users of the first terminal device 200 and the second terminal device 400 is improved.

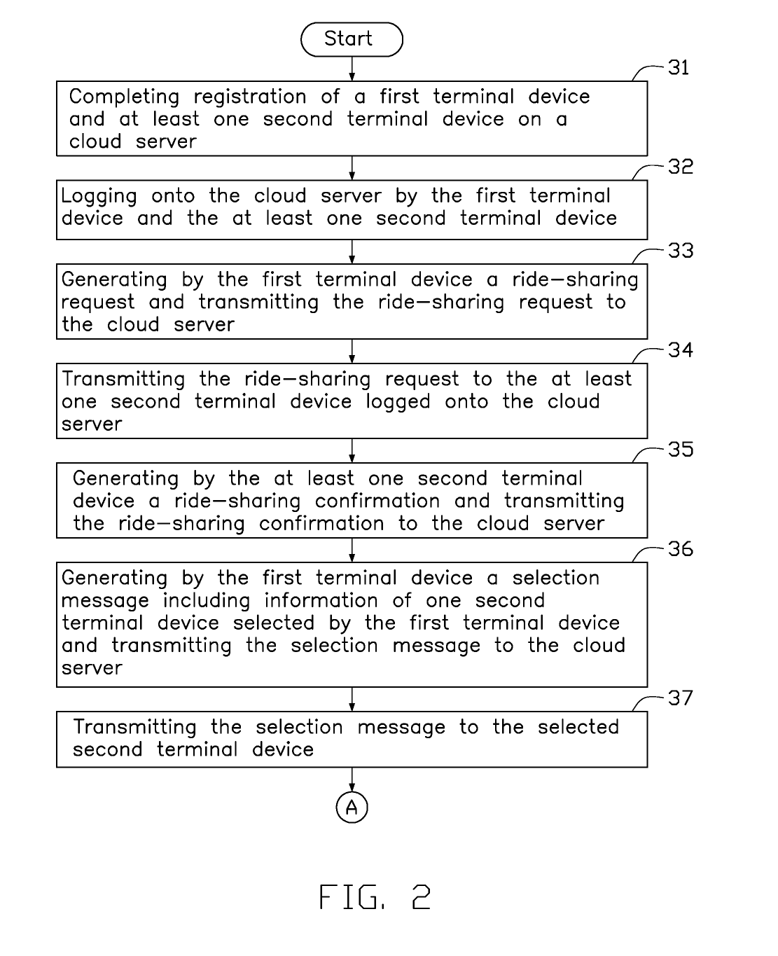

FIG. 2 illustrates a flowchart of an exemplary method for controlling a ride-sharing service. The example method is provided by way of example, as there are a variety of ways to carry out the method. The method described below can be carried out using the configurations illustrated in FIG. 1, for example, and various elements of FIG. 1 are referenced in explaining the example method. Each block shown in FIG. 2 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 31.

At block 31, a first terminal device and at least one second terminal device can complete registration on a cloud server. Registration information of the first terminal device and the at least one second terminal device can include corresponding identification information of the first terminal device and the at least one second terminal device, respectively.

At block 32, the first terminal device and the at least one second terminal device can log onto the cloud server according to the corresponding registration information.

At block 33, the first terminal device can generate a ride-sharing request and transmit the ride-sharing request to the cloud server. In at least one embodiment, the ride-sharing request is in the form of an audio inputted by a user of a first helmet in wireless communication with the first terminal device. The audio can be inputted through a microphone of the first helmet.

At block 34, the cloud server can transmit the ride-sharing request to the at least one second terminal device logged onto the cloud server. In at least one embodiment, the ride-sharing request can be displayed on a second helmet in wireless communication with the at least one second terminal device or played as an audio through a speaker of the second helmet. In at least one embodiment, the ride-sharing request can be converted to text by voice-to-text technology.

At block 35, the at least one second terminal device can generate a ride-sharing confirmation and transmit the ride-sharing confirmation to the cloud server. In at least one embodiment, the ride-sharing confirmation is in the form of an audio inputted by a user of the second helmet. The audio can be inputted through a microphone of the second helmet.

At block 36, the first terminal device can generate a selection message including information of one second terminal device selected by the first terminal device and transmit the selection message to the cloud server. The information can include the identification information of the selected second terminal device.

At block 37, the cloud server can transmit the selection message to the selected second terminal device.

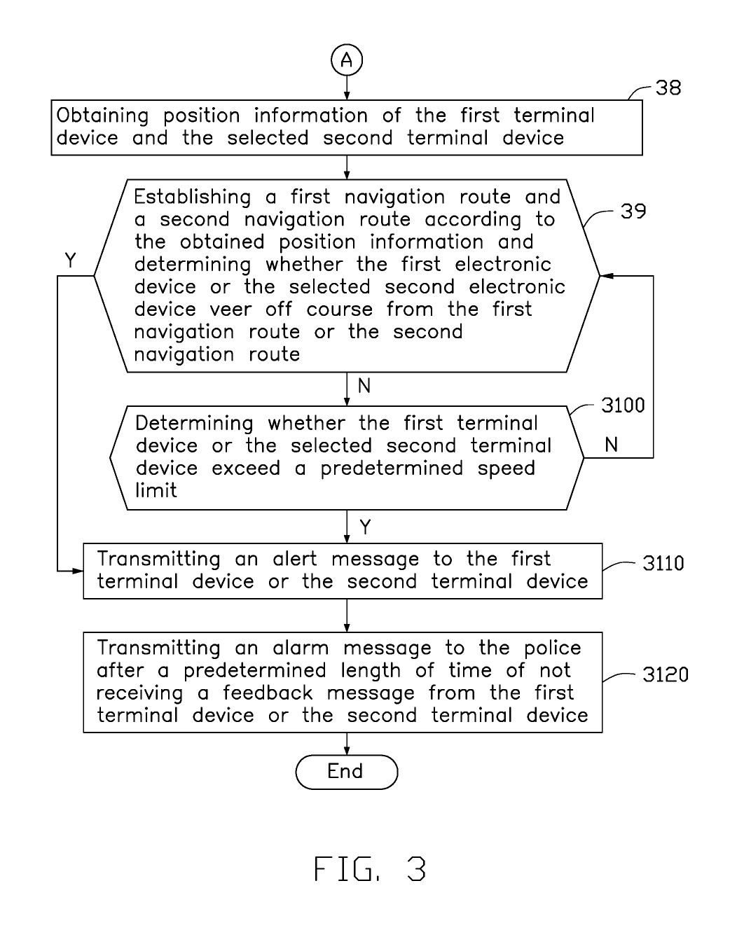

Referring to FIG. 3, at block 38, the cloud server can obtain position information of the first terminal device and the selected second terminal device.

At block 39, the cloud server can establish a first navigation route and a second navigation route according to the obtained position information and determine whether the first electronic device or the selected second electronic device veer off course from the first navigation route or the second navigation route. In at least one embodiment, the first navigation route is a navigation route between the first terminal device and the selected second terminal device, and the second navigation route is a navigation route between the first terminal device and a destination determined by the first terminal device. When it is determined that the first terminal device or the selected second terminal device veers off course, block 3110 is implemented. Otherwise, block 3100 is implemented.

At block 3100, the cloud server can determine whether the first terminal device or the selected second terminal device exceed a predetermined speed limit. The predetermined speed limit refers to a maximum safe speed of travel for a user of the first terminal device and the selected second terminal device. For example, the predetermined speed limit of travel by car may be 60 miles per hour on the highway, and the predetermined speed limit of travel by electric bike may be 20 miles per hour downtown. When it is determined that the first terminal device or the second terminal device exceed the predetermined speed limit, block 3110 is implemented. Otherwise, block 39 is implemented.

At block 3110, the cloud server can transmit an alert message to the first terminal device or the second terminal device to inform the user of the first terminal device or the second terminal device that the first terminal device or the selected second terminal device has veered off course or is traveling faster than the predetermined speed limit.

At block 3120, the cloud server can transmit an alarm message to the police after a predetermined length of time of not receiving a feedback message from the first terminal device or the second terminal device. In at least one embodiment, the feedback message is in the form of an audio input through the microphone of the first helmet or the second helmet.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for controlling a ride-sharing service, the method implemented in a first terminal device, a first helmet paired with the first terminal device, a cloud server, at least one second terminal device, and at least one second helmet paired with the at least one second terminal device, the method comprising:
generating, by the first terminal device when the first helmet is within a predetermined distance from the first terminal device and in response to user input on the first terminal device, a ride-sharing request and wirelessly transmitting the ride-sharing request to the cloud server;
transmitting wirelessly, by the cloud server to the at least one second terminal device, the ride-sharing request;
generating, by the at least one second terminal device when the at least one second helmet is within a predetermined distance from the at least one second terminal device and in response to user input on the at least one second terminal device, a ride-sharing confirmation and wirelessly transmitting the ride-sharing confirmation to the cloud server;
transmitting wirelessly, by the cloud server to the first terminal device, the ride-sharing confirmation;
generating, by the first terminal device in response to user input on the first terminal device, a selection message comprising information of one second terminal device selected by the first terminal device and wirelessly transmitting the selection message to the cloud server; and
transmitting wirelessly, by the cloud server to the selected second terminal device, the selection message.

2. The method as in claim 1, wherein:
the user input for generating the ride-sharing request is in the form of an audio inputted to the first helmet;
the ride-sharing request is transmitted wirelessly to the first terminal device by the first helmet;
the ride-sharing request is transmitted wirelessly to the cloud server by the first terminal device;
the ride-sharing request is transmitted wirelessly to the at least one second helmet;
the ride-sharing request is displayed on the at least one second helmet or played as an audio;
the user input for generating the ride-sharing confirmation is in the form of an audio;
the ride-sharing confirmation is transmitted wirelessly to the corresponding at least one second terminal device; and
the ride-sharing confirmation is transmitted wirelessly to the cloud server by the at least one second terminal device.

3. The method as in claim 1, wherein
the ride-sharing confirmation is transmitted wirelessly to the first helmet and the at least one second helmet;
the ride-sharing confirmation transmitted to the first helmet is displayed on the first helmet or played as an audio by a speaker of the first helmet; and
the ride-sharing confirmation transmitted to the at least one second helmet is displayed on the at least one second helmet or played as an audio by a speaker on the at least one second helmet.

4. The method as in claim 1, further comprising:
obtaining position information in real time of the first terminal device and the selected second terminal device;
establishing according to the position information of the first terminal device and the selected second terminal device a first navigation route between the first terminal device and the selected second terminal device and establishing a second navigation route between the first terminal device and a destination determined by the first terminal device;
transmitting wirelessly the first and second navigation routes to the first terminal device and the selected second terminal device, transmitting wirelessly the position information of the first terminal device to the selected second terminal device, and transmitting wirelessly the position information of the selected second terminal device to the first terminal device;
determining according to the first and second navigation routes whether the first terminal device or the selected second terminal device veer off course from the first or second navigation routes;
transmitting an alert message to the first terminal device when it is determined that the first terminal device veers off course from the first or second navigation route and transmitting the alert message to the selected second terminal device when it is determined that the selected second terminal device veers off course from the first or second navigation route;
determining according to a predetermined speed limit of the first and second navigation routes whether a speed of the first terminal device or the selected second terminal device exceed the predetermined speed limit; and
transmitting the alert message to the first terminal device when it is determined that the first terminal device exceeds the predetermined speed limit and transmitting the alert message to the selected second terminal device when it is determined that the selected second terminal device exceeds the predetermined speed limit.

5. The method as in claim 4, further comprising:
transmitting wirelessly the alert message from the first terminal device to the first helmet and transmitting wirelessly the alert message from the selected second terminal device to the second helmet;
displaying the alert message on the first helmet or playing the alert message as an audio, and displaying the alert message on the second helmet or playing the alert message as an audio;
transmitting wirelessly, according to the alert message, a feedback message in the form of an audio by the first helmet to the first terminal device and transmitting wirelessly, according to the alert message, a second feedback message in the form of an audio by the second helmet to the selected second terminal device;
transmitting wirelessly by the first terminal device the feedback message to the cloud server and transmitting wirelessly by the selected second terminal device the feedback message to the cloud server; and
transmitting wirelessly, by the cloud server within a predetermined length of time of not receiving the feedback message from the first terminal device or the second terminal device, an alarm message to the police.

6. A cloud server in wireless communication with a first terminal device and at least one second terminal device, the cloud server configured to:
receive, from the first terminal device being located within a predetermined distance from a first helmet in wireless communication with the first terminal device, a ride-sharing request;
transmit the ride-sharing request to the at least one second terminal device;
receive, from the at least one second terminal device being located within a predetermined distance from a second helmet in wireless communication with the at least one second terminal device, a ride-sharing confirmation;
transmit the ride-sharing confirmation to the first terminal device;
receive, from the first terminal device, a selection message comprising information of one second terminal device selected by the first terminal device; and
transmit the selection message to the selected second terminal device.

7. The cloud server as in claim 6, wherein:
the ride-sharing request is in the form of an audio;
the ride-sharing request transmitted to the at least one second terminal device is displayed on the second helmet or played as an audio; and
the ride-sharing confirmation is in the form of an audio.

8. The cloud server as in claim 7, wherein:
the ride-sharing confirmation transmitted to the first terminal device is displayed on the first helmet or played as an audio;
the cloud server transmits the ride-sharing confirmation to the at least one second terminal device; and
the ride-sharing confirmation transmitted to the at least one second terminal device is displayed on the second helmet or played as an audio.

9. The cloud server as in claim 6, wherein the cloud server is configured to:
obtain position information in real time of the first terminal device and the selected second terminal device;
establish according to the position information of the first terminal device and the selected second terminal device a first navigation route between the first terminal device and the selected second terminal device and establish a second navigation route between the first terminal device and a destination determined by the first terminal device;
transmit wirelessly the first and second navigation routes to the first terminal device and the selected second terminal device, transmit wirelessly the position information of the first terminal device to the selected second terminal device, and transmit wirelessly the position information of the selected second terminal device to the first terminal device;
determine according to the first and second navigation routes whether the first terminal device or the selected second terminal device veer off course from the first or second navigation routes;
transmit an alert message to the first terminal device when it is determined that the first terminal device veers off course from the first or second navigation route and transmit the alert message to the selected second terminal device when it is determined that the selected second terminal device veers off course from the first or second navigation route;
determine according to a predetermined speed limit of the first and second navigation routes whether a speed of the first terminal device or the selected second terminal device exceed the predetermined speed limit; and
transmit the alert message to the first terminal device when it is determined that the first terminal device exceeds the predetermined speed limit and transmit the alert message to the selected second terminal device when it is determined that the selected second terminal device exceeds the predetermined speed limit.

10. The cloud server as in claim 9 configured to:
receive, from the first terminal device in response to the first alert message, a feedback message and receive, from the selected second terminal device in response to the second alert message, the feedback message; and
transmit wirelessly, within a predetermined length of time of not receiving the feedback message from the first terminal device or the second terminal device, an alarm message to the police.

11. A system for implementing a ride-sharing method, the system comprising:
a cloud server;
a first terminal device in wireless connection with the cloud server;
at least one second terminal device in wireless connection with the cloud server;
a first helmet in wireless connection with the first terminal device; and
a second helmet in wireless connection with the at least one second terminal device;
wherein the first terminal device is configured to generate, when the first helmet is within a predetermined distance from the first terminal device and in response to user input on the first terminal device, a ride-sharing request and transmit the ride-sharing request to the cloud server;
wherein the cloud server is configured to transmit the ride-sharing request to the at least one second terminal device;
wherein the at least one second terminal device is configured to generate, when the at least one second helmet is within a predetermined distance from the at least one second terminal device and in response to user input on the at least one second terminal device, a ride-sharing confirmation and transmit the ride-sharing confirmation to the cloud server;
wherein the cloud server is configured to transmit the ride-sharing confirmation to the first terminal device;
wherein the first terminal device is configured to generate, in response to user input on the first terminal device, a selection message comprising information of one second terminal device selected by the first terminal device and transmit the selection message to the cloud server; and
wherein the cloud server is configured to transmit the selection message to the selected second terminal device.

12. The system as in claim 11, wherein the first terminal device comprises:
a first speed detection unit configured to obtain in real time the speed of the first terminal device and transmit in real time the speed of the first terminal device to the cloud server;
a first global positioning unit configured to obtain in real time the position of the first terminal device and transmit in real time the position of the first terminal device to the cloud server;
a first input unit configured to receive user input thereon and transmit the user input to the cloud server;
a first storage unit configured to store identification information of the first terminal device and first user registration information of the first terminal device; and
a first processing unit configured to transmit the real time speed, the real time position, and the user input of the first terminal device to the cloud server.

13. The system as in claim 12, wherein the at least one second terminal device comprises:
a second speed detection unit configured to obtain in real time the speed of the at least one second terminal device and transmit in real time the speed of the at least one second terminal device to the cloud server;
a second global positioning unit configured to obtain in real time the position of the at least one second terminal device and transmit in real time the position of the at least one second terminal device to the cloud server;
a second input unit configured to receive user input thereon and transmit the user input to the cloud server;
a second storage unit configured to store identification information of the at least one second terminal device and second user registration information of the corresponding at least one second terminal device; and
a second processing unit configured to transmit the real time speed, the real time position, and the user input of the at least one second terminal device to the cloud server.

14. The system as in claim 13, wherein the first helmet comprises:
a first display unit configured to display information thereon;
a first audio input unit configured to receive audio input;
a first audio output unit configured to play audio;
a third storage unit configured to store the identification information of the first terminal device and first user registration information of the first terminal device; and
a first controller configured to control the first display, the first audio input unit, the first audio output unit, and the third storage unit.

15. The system as in claim 14, wherein the second helmet comprises:
a second display unit configured to display information thereon;
a second audio input unit configured to receive audio input;
a second audio output unit configured to play audio;
a fourth storage unit configured to store the identification information of the corresponding at least one second terminal device and second user registration information of the corresponding at least one second terminal device; and
a second controller configured to control the second display, the second audio input unit, the second audio output unit, and the fourth storage unit.

16. The system as in claim 15, wherein the cloud server comprises:
a cloud storage configured to store a user information database, police contact information, a reward system, and a predetermined speed limit, the user information database comprising the first and second user registration information; and
a cloud processor configured to contact the police according to the emergency contact information and execute the reward system.
